(19) United States
(12) Patent Application Publication
(10) Pub. No.: US 2025/0099892 A1
(43) Pub. Date: Mar. 27, 2025

(54) MODULAR FILTER SYSTEM WITH SHAKE AND PULSE CLEANING FOR DUSTY ENCLOSURES

(71) Applicant: Michael W. Seitz, Tomball, TX (US)

(72) Inventor: Michael W. Seitz, Tomball, TX (US)

(21) Appl. No.: 18/291,133

(22) PCT Filed: Jul. 27, 2022
(86) PCT No.: PCT/US2022/038542

§ 371 Date: Jan. 22, 2024

Related U.S. Application Data
(60) Provisional application No. 63/226,482, filed on Jul. 28, 2021.

(51) Int. Cl. B01D 46/76; B01D 46/00; B01D 46/24; B01D 46/71

(52) U.S. Cl. CPC B01D 46/76; B01D 46/0005; B01D 46/2411; B01D 46/71

(57) ABSTRACT

In a filtration device comprising tubular filters, a reverse jet cleaning system is combined with a filter vibrating system, with both systems being activated simultaneously. This combined action results in the jets reversing the flow for a brief time (usually less than 1 second), while a strong vibration system (or ultrasonic) vibrates the filter cartridge to dislodge the dust. Vibration is enhanced when the aperture plate supporting the cartridges is formed of sheet metal.

### TECHNICAL FIELD

Certain industrial operations generate large amounts of dust. For health, environmental and safety reasons, air filtration systems, often employing filter cartridges, are employed to cleanse the air and capture the dust.

### BACKGROUND ART

The device of my U.S. Pat. No. 10,668,420 was for a portable filtration unit that could be placed alongside dusty enclosures to remove the dust with the collected dust falling into a container not being integral to the dust generating activity.

During operation, the dust collects on the outside of the tubular filter walls as cake and is dislodged to fall into the container by a reverse jet cleaning system comprising an axial pulse of air propagated down the inside of the filter. In some applications, the axial pulse of gas fails to provide sufficient cleaning of the filters.

### DISCLOSURE OF INVENTION

In this invention, a reverse jet cleaning system is combined with a filter vibrating system, with both systems being activated simultaneously. This combined action results in the jets reversing the flow for a brief time (usually less than 1 second), while a vibration system (or ultrasonic) vibrates the filter cartridge to dislodge the dust. Vibration and cleaning is further enhanced when the aperture plate supporting the tubular filter cartridges is formed of sheet metal of lesser gauge thickness than is normally employed in a very rigid design. The combined method is very effective for dislodging the dust and simultaneously “blowing it off” the surface.

### BRIEF DESCRIPTION OF THE DRAWINGS

FIG. 1 is a pictorial representation of a portion of an aperture plate supporting multiple tubular filters having provision for pulse-jet and vibration cleaning.

FIG. 2 is a pictorial representation of a cartridge of multiple tubular filters that can be deployed as a unit with suitable handling equipment.

FIG. 3 is a pictorial representation of a unit containing a pair of cartridge units and a fan unit.

FIG. 4 is a schematic sectional view of another type of filter unit embodying certain features of the invention.

### BEST MODE FOR CARRYING OUT THE INVENTION

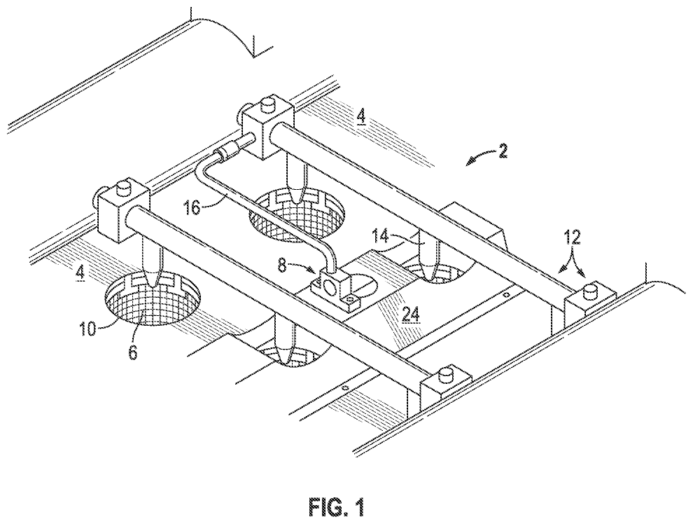

In the embodiment of the invention shown in FIG. 1, there shown an apparatus 2 comprising an aperture plate 4, a plurality of tubular filters 6, and a vibrator 8. The aperture plate defines a plurality of apertures 10 and the plurality of tubular filters hangs from the apertures, one per aperture. The vibrator is attached to the aperture plate for shaking the plurality of tubular filters. The vibrator can be attached to the plate directly or indirectly so long as it is functionally attached to the plate in a way that the vibrations of the vibrator are transmitted to the plate.

In a preferred embodiment, the apparatus further comprises a pulse-jet assembly 12. The pulse-jet assembly includes a plurality of nozzles 14 for pulsing jets of gas down the plurality of filters, one nozzle per filter, and a conduit 16 connecting the pulse jet assembly to the vibrator for actuating the vibrator pneumatically when the plurality of filters is pulsed.

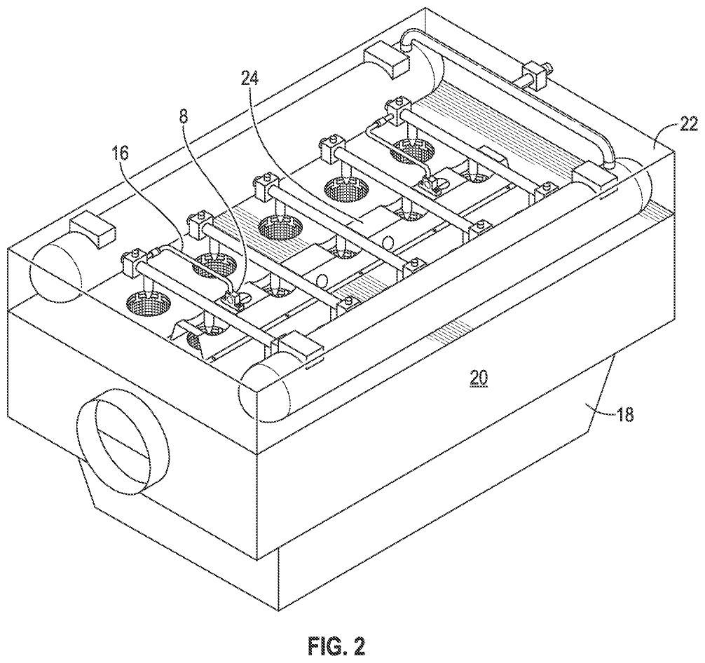

With reference to FIG. 2, a receptacle 18 is positioned beneath the plurality of tubular filters for collecting dust dislodged by the shaking and the pulsing jets. A dusty gas distributor 20 supplies dusty gas into the volume surrounding the tubular filters.

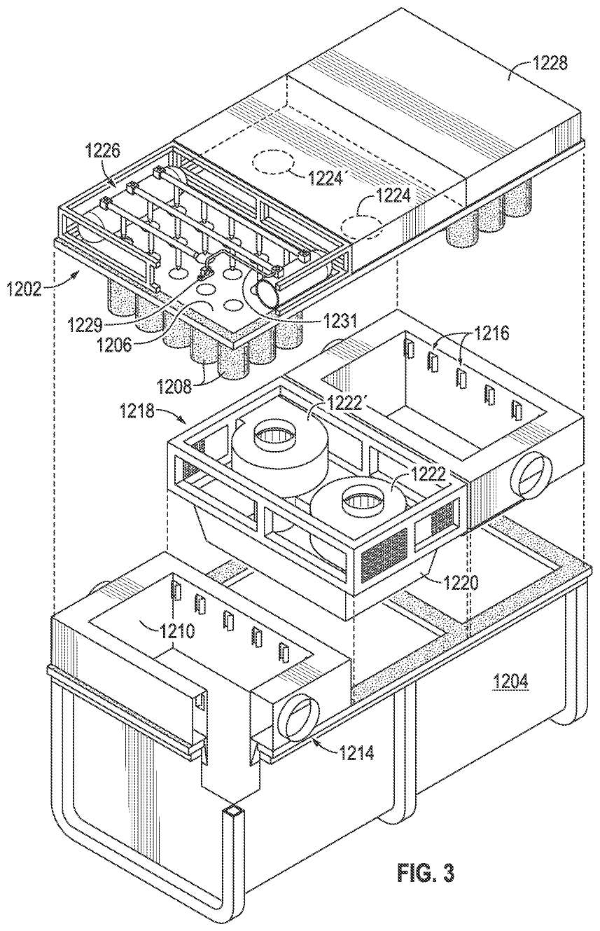

An enclosure 22 surrounds the pulse jet assembly. An exhaust fan 1222 (See FIG. 3) is connected to the enclosure for drawing gas from the dirty gas distributor and through the walls of the plurality of tubular filters.

In a preferred embodiment, the aperture plate is constructed of sheet metal and the vibrator is attached to an elongated stiffener 24 extending at least partway across the aperture plate. In the illustrated embodiment, the elongated stiffener comprises a hat-shaped beam. The vibrator in the illustrated embodiment is a pneumatic turbine ball vibrator and comprises a ball riding in a circular race. A vibrator that spins at a maximum rpm in the range of 15,000 to 30,000 rpm has been used with good results. The vibrations continue for a while after the reverse flow of air is discontinued as the ball spins down. Other vibrators, for example electronic or other types of mechanical vibrators, could be used if desired.

The aperture plate can be any size, but a steel aperture plate that measures from 1 to 3 meters wide and from 2 to 5 meters long and has a thickness in the range of 0.4 to 4 mm, preferably 1-3 mm, most preferably about 2 mm, has been employed with good results. A hat-shaped stiffener that extends along the length of the aperture plate and has a thickness in the range of 2 to 6 mm, preferably 3-5 mm, has been employed with good results. A steel stiffener has been used with good results. A stiffener that is wider than and straddles a row of apertures has been used with good results. A stiffener that has cutouts aligned with the apertures it is in covering relationship with has been used with good results.

The combination of a turbine ball vibrator coupled to a sheet metal aperture plate having a thickness, length and width within the above ranges provides especially efficacious results. In one embodiment, the thin aperture plate vibrates or bounces like a drum when the vibrator is actuated, and the motion is transmitted to the filters.

In the embodiment of the invention shown in FIG. 3, the required filters can be deployed as units in one or more magazines 1202 of filter cartridges, the magazines being shaped to fit a rectilinearly shaped dust bin 1204, or any hopper or hopper system having a mouth which will accept one or more magazines. The bin can have a rectangularly shaped open upper end bounded by four opposed side walls. Each magazine can comprise an aperture plate 1206 and a plurality of filters 1208. Each aperture plate can define a plurality of apertures and be sized to form at least a partial ceiling for the bin. The apertures are preferably arranged in rows and columns. A plurality of tubular filters sized to hang into the bin from the apertures are deployed, one per aperture. In a preferred embodiment, four side walls extend in a direction normal to the aperture plate peripherally to the plurality of tubular filters and form an open-bottomed box having a height sufficient to contain the tubular filters. A dirty gas distribution means 1214 is positioned to distribute dirty gas into the upper end of the bin from a peripheral location with respect to the aperture area of the plate. The dirty gas distribution means preferably comprises a pair of parallel tubular sidewalls forming a pair of tunnels spaced apart from each other at a spacing distance so as to rest on the upper ends of opposed bin sidewalls. A second pair of tubular sidewalls can connect the ends of the first pair so that the distributor is generally rectangular as in the illustrated embodiment.

The tubular sidewalls forming the distributor preferably each has opposite top and bottom walls, and opposite outer and inner walls, and the top wall is approximately coplanar with the aperture plate. This permits the filters to hang into the bin when the magazine is deployed in a way to reduce overall equipment height.

In one embodiment of the invention, the inside walls of the distributor are provided with nozzles 1216 that direct the dirty gas flow away from direct impingement on the filters, generally between the rows and/or columns of filters. Preferably the flow is directed between the rows. The nozzles can be formed by making “I” shaped cuts in the wall of the distributor, leaving opposed “wings” alongside the vertical cut, and then bending the opposed wings outwardly to form rectangular openings in the wall of the distributor bounded by the bent wings (louvers) inclined toward each other. The purpose of the louvers is to reduce erosion of the filters by particle impingement.

The magazine is preferably deployed in combination with a portable bin 1204, although it can also be used in conjunction with fixed collector systems employing hoppers and like. A hopper is essentially a bin with a converging bottom leading to an outlet. A plurality of magazines for filter cartridges can be positioned on larger bins to form at least a partial ceiling for the bin. For example, the aperture plate and dirty gas distributor can measure, say about 8 feet (2.4 m) by about 5 feet (1.5 m), and three magazines can be deployed side by side to cover an 8×15 foot (2.4×4.6 m) bin. Each magazine can contain 15 filters, arranged in a 5×3 array.

If desired, a modular fan unit 1218 can be positioned directly on the bin alongside one or more of the magazines. Preferably, the fan unit has the same footprint on the bin as one of the magazines for the filter cartridges. The fan unit includes a tray 1220 to partly house one or more blowers and to form part of the ceiling for the bin. The tray is positioned sealingly across the bin. The tray protrudes into the dust collecting chamber of the bin and partly bounds the dust collecting chamber. The at least one blower in the housing has an intake drawing from the overhead clean air chamber. In one embodiment, the blower intake is through a cell plate defining apertures 1224, 1224′ so that the fan unit housing outside of the internal passage through the blower is sealed from both the clean air chamber and the dust collecting chamber. In one embodiment the blower exhausts from the blower housing laterally. As an example, and as illustrated in FIG. 3, an 8×15 foot (2.4×4.6 m) bin can be provided with a pair of approximately 5×8 foot (1.5×2.4 m) magazines and an approximately 5×8 foot (1.5×2.4 m) blower unit situated between them.

A pulse jet assembly 1226 is preferably positioned in the clean air chamber above each filter cartridge assembly. Each pulse jet assembly preferably comprises a pair of generally parallel generally cylindrical reservoirs for storing compressed air, a plurality of generally parallel cross pipes extending between the pair of reservoirs, each cross-pipe being generally in superposition with a row of apertures on the cell plate, and a plurality of nozzles extending laterally from the plurality of cross pipes, each nozzle being in alignment with a longitudinal axis of a tubular filter depending from the cell plate. Quick acting valves regulate entry of the pressurized gas into the cross pipes. The pulse jet assembly is preferably of unitized construction and is contained in an open-bottomed box 1228 comprised of lateral sidewalls and a roof. A pneumatic rotary vibrator 1229 is connected to the aperture plate, preferably via a reinforcing structure not shown, and powered via a line 1231 drawing from one of the cross pipes when the pulse jet assembly is activated.

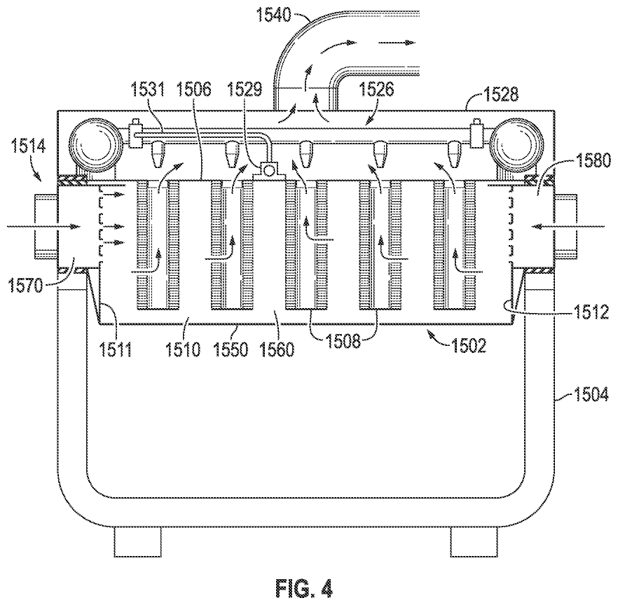

In the embodiment of the invention shown in FIG. 4, the required filters can be deployed as units in one or more magazines 1502 of filter cartridges, the magazines preferably being shaped to fit a rectilinearly shaped dust bin 1504 or any hopper or hopper system having a mouth which will accept one or more magazines. The bin can be as described before, with a rectangularly shaped open upper end bounded by four opposed side walls. Each magazine comprises an aperture plate 1506 and a plurality of filters 1508. Each aperture plate defines a plurality of apertures and is sized to form at least a partial ceiling for the bin, and preferably a total ceiling for the magazine. The apertures are preferably arranged in rows and columns. A plurality of tubular filters sized to hang into the bin from the apertures are deployed, one per aperture. In a preferred embodiment, four depending side walls 1510, 1511, 1512 shown, extend in a direction normal to the aperture plate peripherally to the plurality of tubular filters and are closed by a bottom plate 1550 to form a closed-bottomed box having a height sufficient to contain the tubular filters. The box forms a dust collection chamber 1560. When the dust capacity of the chamber has been reached, the entire magazine, dust, filters and all, is removed and safely disposed of. The side and bottom walls of the magazine are preferably formed of sheet metal, to hold down costs. In one embodiment, (FIG. 4), a dirty gas distribution means 1514 is positioned to distribute dirty gas into the dust collection chamber from a peripheral location with respect to the aperture area of the plate. The dirty gas distribution means preferably comprises a pair of parallel tubular sidewalls forming a pair of tunnels 1570, 1580 spaced apart from each other. Where the magazine is deployed on a bin, the tunnels are preferably spaced at a spacing distance so as to rest on the upper ends of opposed bin sidewalls. See FIG. 4. A second pair of tubular sidewalls can connect the ends of the first pair so that the distributor is generally rectangular in one embodiment. The tubular sidewalls can be provided with nozzles directed between the filters as described elsewhere herein if desired.

The tubular sidewalls forming the distributor preferably each has opposite top and bottom walls, and opposite outer and inner walls, and the top wall is approximately coplanar with the aperture plate. This permits the filters to hang into the closed dust collection chamber of the magazine in a way to reduce overall equipment height.

The closed-bottom magazines can be deployed in the same applications and with the same associated bins, exhaust conduit 1540, blowers, a pulse-jet assembly 1526, vibrator 1529 and supply conduit 1531, a cover 1528, etc., as the open-bottom magazines described herein, or without a surrounding bin or hopper if desired.

### Example

A Bluesky dust collector had been running with a new set of filters for about two weeks servicing several plasma cutting machines, when it began showing signs of the filters blocking (low airflow) and not cleaning adequately. After 4 weeks the client indicated the filters where in poor condition. These filters where then replaced, and the unit was modified to employ a shake and pulse system as described herein using K10 Industrial Pneumatic Turbine Ball Vibrators. Weekly follow up confirmed that after 2 months the system was still functioning with excellent performance. The client reported the problem was solved. This case study showed, that without resorting to other methods, the cleaning of the filters was significantly improved by the simultaneous “vibrate and pulse” method.

What is claimed is:

1. Apparatus comprising
an aperture plate defining a plurality of apertures, a plurality of tubular filters hanging from the apertures, one per aperture, and a vibrator attached to the aperture plate for shaking the plurality of tubular filters.

2. Apparatus as in claim 1 further comprising
a pulse-jet assembly including a plurality of nozzles for pulsing jets of gas down the plurality of filters, one nozzle per filter, and a conduit connecting the pulse jet assembly to the vibrator for actuating the vibrator when the plurality of filters is pulsed, wherein the vibrator is pneumatically actuated.

3. Apparatus as in claim 2 further comprising
a receptacle beneath the plurality of tubular filters for collecting dust dislodged by the pulsing jets and shaking.

4. Apparatus as in claim 3 further comprising
a dusty gas distributor for supplying dusty gas into a volume surrounding the tubular filters,
an enclosure surrounding the pulse jet assembly, and
an exhaust fan connected to the enclosure for drawing gas from the dirty gas distributor and through the walls of the plurality of tubular filters.

5. Apparatus as in claim 4 wherein
the aperture plate is constructed of sheet metal and the vibrator is attached to an elongated stiffener extending at least partway across the aperture plate.

6. Apparatus as in claim 5 wherein the aperture plate measures from 1 to 3 meters wide and from 2 to 5 meters long and has a thickness in the range of 0.4 to 4 mm.

7. Apparatus as in claim 1 further comprising
a pulse-jet assembly including a plurality of nozzles for pulsing jets of gas down the plurality of filters, one nozzle per filter, and a conduit connecting the pulse jet assembly to the vibrator for actuating the vibrator when the plurality of filters is pulsed, wherein the vibrator is electrically actuated.

8. A removable magazine assembly for filter cartridges comprising an aperture plate defining a plurality of apertures, a plurality of tubular filters hanging from the apertures, one per aperture, a vibrator attached to the aperture plate, a dirty gas distribution means supporting the aperture plate and positioned to distribute dirty gas laterally from a peripheral location with respect to the filters to locations between the filters, said dirty gas distribution means comprising a pair of parallel tunnels spaced apart from each other and nozzles to direct dirty gas from the tunnels to between the filters, and four side walls attached to the dirty gas distribution means and extending in a direction normal to the aperture plate and peripherally to the plurality of tubular filters to form an open-bottomed box having a height sufficient to contain the tubular filters, wherein each tunnel is defined by a tubular sidewall having opposite top and bottom walls, and outer and inner walls, and the top wall supports the aperture plate.

9. A magazine for filter cartridges comprising an aperture plate defining a plurality of apertures, a plurality of tubular filters hanging from the apertures, one per aperture, a vibrator attached to the aperture plate, a dirty gas distribution means positioned to distribute dirty gas from a peripheral location with respect to the filters, said dirty gas to distribution means comprising a first pair of parallel tubular sidewalls forming a pair of tunnels spaced apart from each other, and a second pair of tubular sidewalls connecting the ends of the first pair, and four side walls attached to the dirty gas distribution means and extending in a direction away from the aperture plate and peripherally to the plurality of tubular filters to form a box having a height sufficient to contain the tubular filters, and an end closure on the box opposite the aperture plate to form a dust collection chamber for collected dust, said magazine for filter cartridges being positioned on a bin and forming at least a partial ceiling for the bin and being removable as a unit from the bin for disposal of collected dust along with the unit.

10. Apparatus comprising a bin and a magazine for filter cartridges positioned on the bin, said magazine for filter cartridges comprising an aperture plate defining a plurality of apertures, a plurality of tubular filters hanging from the apertures, one per aperture, a vibrator attached to the aperture plate, a dirty gas distribution means positioned to distribute dirty gas from a peripheral location with respect to the filters, said dirty gas to distribution means comprising a first pair of parallel tubular sidewalls forming a pair of tunnels spaced apart from each other, and a second pair of tubular sidewalls connecting the ends of the first pair, and four side walls attached to the dirty gas distribution means and extending in a direction away from the aperture plate and peripherally to the plurality of tubular filters to form a box having a height sufficient to contain the tubular filters and an end closure on the box opposite the aperture plate to form a dust collection chamber for collected dust, said magazine for filter cartridges being positioned on the bin and forming at least a partial ceiling for the bin and being removable as a unit from the bin for disposal of collected dust along with the unit, wherein the tubular sidewalls each has opposite top and bottom walls, and outer and inner walls, and the top wall supports the aperture plate.

11. Apparatus as in claim 10 wherein the bin comprises an exchangeable rectilinear bin having an open upper end and a closed lower end, a roof is positioned above the at least one aperture plate, a clean-gas chamber is defined between the at least one aperture plate and the roof, said clean-gas chamber being partly defined by a peripheral wall extending between the at least one aperture plate and the roof, and a pulse-jet assembly is positioned at least partly in the clean-gas chamber, said pulse-jet assembly including a plurality of nozzles for pulsing jets of gas down the plurality of filters, one nozzle per filter, and a conduit connecting the pulse jet assembly to the vibrator for actuating the vibrator when the plurality of filters are pulsed, said apparatus further comprising an exhaust fan connected to the clean-gas chamber for drawing gas from the dirty gas distributor and through the walls of the plurality of tubular filters.
